(19) United States
(12) Patent Application Publication
(10) Pub. No.: US 2017/0243256 A1
(43) Pub. Date: Aug. 24, 2017

(54) METHOD AND DEVICE FOR CONTROLLING DISPLAYING OF MEDIA OBJECT AND MEDIA OBJECT DISPLAY SYSTEM

(71) Applicant: BEIJING BAIDU NETCOM SCIENCE AND TECHNOLOGY, LTD., Beijing (CN)

(72) Inventors: Hengyu Li, Beijing (CN); Jun Peng, Beijing (CN)

(73) Assignee: BEIJING BAIDU NETCOM SCIENCE AND TECHNOLOGY, LTD., Beijing (CN)

(21) Appl. No.: 15/122,600

(22) PCT Filed: Jul. 14, 2015
(86) PCT No.: PCT/CN2015/083969

§ 371 Date: Aug. 30, 2016

(30) Foreign Application Priority Data
Nov. 11, 2014 (CN) 201410645367.9

(51) Int. Cl. G06Q 30/02; G06Q 30/04; G06F 17/30

(52) U.S. Cl. CPC G06Q 30/0273; G06F 17/30058; G06F 17/30377; G06Q 30/04; G06Q 30/0249

(57) ABSTRACT

The disclosure provides a method and device for controlling displaying of a media object and a media object display system. The method includes: updating a consumed value of the media object based on a current click on the media object by a user after the user clicks the media object; performing a determination based on the consumed value of the media object and a pre-stored budget of the media object; and generating and sending an offline message for instructing a related system to perform an offline processing on the media object when the consumed value of the media object is determined to reach the budget. The method reduces the overall delay, improves the accuracy in controlling the media object display according to the budget, and decreases the waste of system resources caused by redundant processing.

The present application claims the priority of Chinese Patent Application No. 201410645367.9, filed before the State Intellectual Property Office on Nov. 11, 2014, entitled “Method and Device for Controlling Displaying of Media Object and Media Object Display System,” the entire disclosure of which is incorporated herein by reference.

### TECHNICAL FIELD

The present invention relates to a method and device for controlling displaying of a media object and a media object display system.

### BACKGROUND

In the prior art, displaying of a media object is controlled as follows. After a user clicks a media object, the click is recorded in the form of a log, and then anti-fraudulence filtering is carried out. After the click is determined as a valid click, billing (i.e., accumulating the current click's consumption value on the basis of the consumed value) is carried out and it is determined whether the billing result reaches a budget. If the billing result reaches the budget, an advertisement status field in a database is modified; and then the advertisement status in the database is transferred to an advertisement display system through a status transmission system, such that the advertisement displaying system carries out off-line processing of the media object according to the advertisement status.

The prior art has the following defects:

1) The control of the displaying of a media object depends on a database that has a high failure rate. Once a failure occurs, not only the budget control is severely impacted, but also the displaying of the media object may be uncontrollable.
2) The control of the displaying of a media object has a real-time dependency on the anti-fraudulence process. Namely, the budget control must be carried out based on a result of the anti-fraudulence process so that the displaying of the media object is controlled, which leads to a relatively long delay between the clicking of the media object by the user and the determination that the media object needs to be offline. The dependence on the database also leads to a relatively long delay between the determination that the media object needs to be offline and the performing of the offline process. Hence, the processing efficiency of the system may be decreased.
3) Due to the existence of the above-mentioned relatively long delays, between the clicking of the media object by the user and the performing of the offline process, the system will continuously receive users' clicks (which already exceed the budget), and perform processes such as log recording, anti-fraudulence filtering, and billing etc. Such redundant processes waste system resources.

### SUMMARY

In order to solve the defects in the existing media object displaying control technology, provided in embodiments of the present invention are a method and device for controlling displaying of a media object and a media object display system, which are able to effectively and timely control the displaying of a media object, and reduce the waste of system resources due to redundant processes.

In an aspect, embodiments of the present invention provide a method for controlling displaying of a media object, including:

updating a consumed value of the media object based on a current click on the media object by a user after the user clicks the media object;
performing a determination based on the consumed value of the media object and a pre-stored budget of the media object; and
generating and sending an offline message for instructing a related system to perform an offline processing on the media object when the consumed value of the media object is determined to reach the budget.

Alternatively, in an implementation of the embodiments of the present invention, the updating of a consumed value of the media object based on a current click on the media object by a user after the user clicks the media object includes:

updating the consumed value of the media object according to a consumption value carried in a user click message when the user click message generated by a media click service subsystem is acquired; wherein the media click service subsystem is configured to receive a click on the media object by the user, and generate the user click message indicating that the user clicks the media object when the click on the media object by the user is received.

Alternatively, in another implementation of the embodiments of the present invention, the method further includes:

determining whether the current click is an invalid click according to an anti-fraudulence strategy, or determining whether the current click is an invalid click according to an acquired indicating message generated by a third-party subsystem, the third-party subsystem being configured to generate the indicating message based on whether the current click is an invalid click; and performing a restoring processing if the current click is an invalid click, the restoring processing including: restoring the consumed value of the media object to the value before the updating; and generating and sending an online message for instructing the related system to perform an online processing on the media object.

Alternatively, in yet another implementation of the embodiments of the present invention, the method further includes: changing a preset status flag from an online status to an offline status and generating the offline message according to the status flag, when the consumed value of the media object is determined to reach the budget; and changing the status flag from the offline status to the online status and generating the online message according to the status flag, when the current click is determined to be an invalid click.

Accordingly, embodiments of the present invention also provide a device for controlling displaying of a media object, including:

a consumption updating module configured to update a consumed value of the media object based on a current click on the media object by a user after the user clicks the media object; a first determining module configured to perform a determination based on the consumed value of the media object and a pre-stored budget of the media object, and trigger a processing module in case that the consumed value of the media object is larger than or equal to the pre-stored budget of the media object; and
the processing module configured to generate and send an offline message for instructing a related system to perform an offline processing on the media object.

Alternatively, in an implementation of the embodiments of the present invention, the consumption updating module includes:

a message acquiring submodule configured to acquire a user click message generated by a media click service subsystem, and trigger an updating submodule when the user click message is acquired; and
the updating submodule configured to update the consumed value of the media object according to a consumption value carried in the user click message;
wherein the media click service subsystem is for receiving a click on the media object by the user, and generating the user click message indicating that the user clicks the media object when the click on the media object by the user is received.

Alternatively, in another implementation of the embodiments of the present invention, the device further includes a second determining module configured to determine whether the current click is an invalid click according to an anti-fraudulence strategy or according to an acquired indicating message generated by a third-party subsystem, the third-party subsystem being configured to generate the indicating message based on whether the current click is an invalid click; wherein the consumption updating module is further configured to restore the consumed value of the media object to the value before the updating when the second determining module determines that the current click is an invalid click; and the processing module is further configured to generate and send an online message for instructing the related system to perform an online processing on the media object when the second determining module determines that the current click is an invalid click.

Alternatively, in yet another implementation of the embodiments of the present invention, the device further includes:

a status flag module configured to change a preset status flag from an online status to an offline status when the first determining module determines that the consumed value of the media object is larger than or equal to the budget, such that the consumption updating module generates the offline message according to the status flag, and configured to change the status flag from the offline status to the online status when the second determining module determines that the current click is an invalid click, such that the processing module generates the online message according to the status flag.

Accordingly, embodiments of the present invention further provide a media object display system, including:

the device for controlling displaying of a media object according to the embodiments or its implementations of the present invention; and
an advertisement displaying subsystem configured to acquire a message generated by the device, and perform an online processing or an offline processing on the media object according to the acquired message.

Alternatively, in an implementation of the embodiments, the system further includes a media click service subsystem configured to receive a click on the media object by the user, and generate and send a user click message indicating that the user clicks the media object after the click by the user is received, such that the device acquires the user click message so as to update the consumed value of the media object.

Alternatively, in another implementation of the embodiments, the system further includes a third-party subsystem configured to generate an indicating message based on whether the current click is an invalid click, such that the device acquires the indicating message and determines whether the current click is an invalid click according to the indicating message.

Alternatively, the third-party subsystem is an anti-fraudulence subsystem configured to determine whether the current click is an invalid click according to an anti-fraudulence strategy, and generate the indicating message based on a result of the determining. Or, the system further includes an anti-fraudulence subsystem configured to determine whether the current click is an invalid click according to an anti-fraudulence strategy, wherein the third-party subsystem is a billing subsystem configured to determine whether a billing processing is performed based on a result of the determining of the anti-fraudulence subsystem, and if the result of the determining is that the current click is an invalid click, the third-party subsystem does not perform the billing processing and generates an indicating message for indicating that the billing processing is not performed, such that the device determines that the current click is an invalid click according to the indicating message.

Accordingly, embodiments of the present invention further provide a device, including: one or more processors; a memory; and one or more programs. The one or more programs are stored in the memory, and when the one or more programs are executed by the one or more processors, operations are carried out, the operations including the steps included in the above-mentioned method for controlling displaying of a media object or the implementations thereof.

Accordingly, embodiments of the present invention further provide a non-transitory computer storage medium storing one or more programs, the one or more programs when executed by a device, causing the device to perform operations comprising the steps in the method for controlling displaying of a media object or the implementations thereof.

By adopting the embodiments of the present invention, the following beneficial effects may be produced.

During the control of displaying of a media object, dependence on a database and real-time dependence on an anti-fraudulence processing are removed, which not only avoids uncontrollability of media object displaying caused by a high failure rate of the database, but also reduces the overall delay. The accuracy in controlling the displaying of a media object according to the budget is improved, and the waste of system resources caused by redundant processing is reduced.

### BRIEF DESCRIPTION OF THE DRAWINGS

FIG. 1 is a schematic flowchart of a method for controlling displaying of a media object according to an embodiment of the present invention;

FIG. 2 is a schematic flowchart of a method for controlling displaying of a media object according to an embodiment of the present invention;

FIG. 3 is a schematic block diagram of a device for controlling displaying of a media object according to an embodiment of the present invention;

FIG. 4 is a schematic block diagram of a device for controlling displaying of a media object according to an embodiment of the present invention;

FIG. 5 is a schematic block diagram of a media object display system according to an embodiment of the present invention;

FIG. 6 is a schematic block diagram of a media object display system according to an embodiment of the present invention; and

FIG. 7 is a schematic diagram of a data flow in a process of controlling displaying of a media object according to an embodiment of the present invention.

### DETAILED DESCRIPTION

Various aspects of the present invention will be described below in detail with reference to the accompanying drawings and specific embodiments. Well-known modules, units, and connections, links, communications or operations therebetween are not shown or described in detail. Additionally, the described features, architectures or functions may be combined in any way in one or more embodiments. It should be appreciated by a person skilled in the art that the embodiments described below are merely intended to provide exemplary description, rather than limiting the protection scope of the present invention. It may also be readily appreciated that modules, units or steps in embodiments described in this disclosure and shown in the accompanying drawings may be combined and designed according to various configurations.

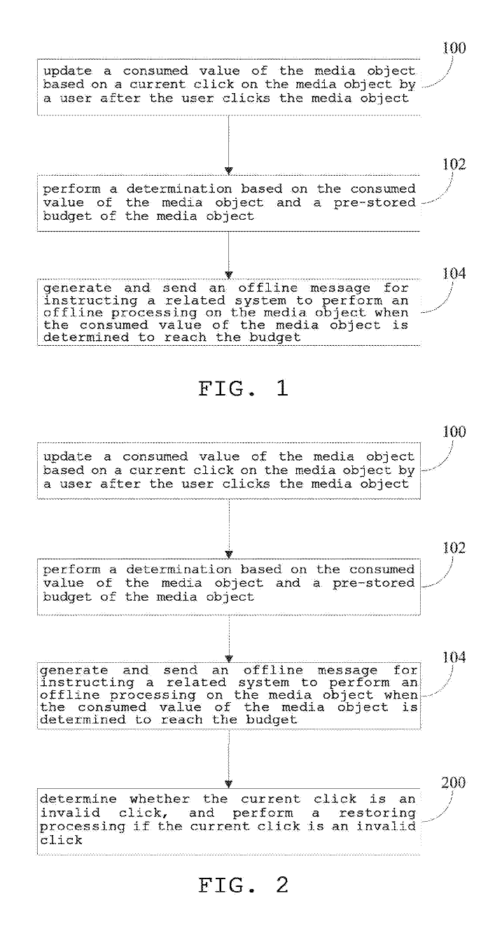

FIG. 1 is a schematic flowchart of a method for controlling displaying of a media object according to an embodiment of the present invention. Referring to FIG. 1, the method includes the following.

100: A consumed value of the media object is updated based on a current click on the media object by a user after the user clicks the media object.

In this disclosure, the “media object” refers to content that is displayed by a media and may be clicked by users, for example, an advertisement displayed on a webpage, and a search result displayed on a search page etc. Each click on the media object by the users may consume a budget of the advertiser (i.e., the advertising party), and a consumed value of the media object is obtained by accumulating the consumption value of each user click.

It should be noted that “current click” mentioned in this disclosure refers to a user's raw click, namely, a click that has not been determined as to whether it is an invalid click.

Alternatively, in an implementation of the embodiments, when a user click message indicating that a user has clicked the media object is acquired, the consumed value of the media object is updated according to the consumption value carried in the user click message. For example, a media click service subsystem for receiving clicks on media objects by users may generate a user click message when a user's click is received.

Alternatively, in another implementation of the embodiment, when the user click message is acquired, the consumed value of the media object may be updated according to a pre-stored consumption value of a single click on the media object.

102: A determination is performed based on the consumed value of the media object and a pre-stored budget of the media object.

Alternatively, in an implementation of the embodiment, the budget of the media object may be acquired from a database, and saved.

104: An offline message for instructing a related system to perform an offline processing on the media object is generated and sent when the consumed value of the media object is determined to reach the budget.

Alternatively, in an implementation of the embodiment, the related system may be an existing advertisement displaying system, which performs the offline processing on the media object according to the offline message.

By using the method provided in this embodiment, the real-time dependence on the anti-fraudulence processing during the control of the displaying of a media object is removed by means of the billing processing and determining processing performed based on the current click, such that it may be determined in time whether an offline processing is to be performed. By generating and sending the offline message when it is determined that the consumed value of the media object reaches the budget, the dependence on the database is removed, such that the related system may be notified in time to perform the offline processing, and the overall delay in the process of controlling the displaying of a media object based on the budget is reduced, and redundant data processing is also reduced.

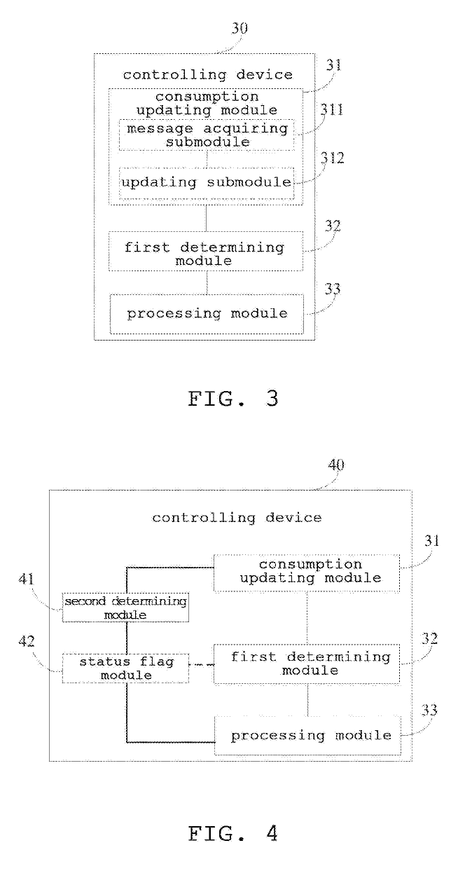

FIG. 2 is a schematic flowchart of a method for controlling displaying of a media object according to an embodiment of this disclosure. Referring to FIG. 2, in addition to steps 100, 102, and 104, the method further includes:

200: It is determined whether the current click is an invalid click, and a restoring processing is performed if the current click is an invalid click.

In this embodiment, whether the current click is an invalid click may be determined in the following approaches.

Approach 1: It is determined whether the current click is an invalid click according to an anti-fraudulence strategy. The anti-fraudulence strategy may be an existing strategy, and the detailed description of the anti-fraudulence strategy is omitted herein.

Approach 2: it is determined whether the current click is an invalid click according to an acquired indicating message generated by a third-party subsystem, the third-party subsystem being configured to generate the indicating message based on whether the current click is an invalid click.

Illustratively, the third-party subsystem may be an anti-fraudulence subsystem that determines whether the current click is an invalid click according to the anti-fraudulence strategy, and generates the indicating message based on the result of the determining.

Alternatively, the third-party subsystem may be a billing subsystem that acquires the determination result of the anti-fraudulence subsystem, performs billing on the current click if the current click is a valid click (the result of billing in this case is the consumed value calculated based on the valid click, which differs from the consumed value calculated based on the current click in step 100), and otherwise, the billing processing is not performed, and an indicating message for indicating the un-billing of the current click is generated in case of un-billing. The current click may be determined as an invalid click according to the indicating message.

In this embodiment, the restoring processing may include: restoring the consumed value of the media object to the value before the updating (e.g., the consumption value of the current click is subtracted from the consumed value of the media object); and generating and sending an online message for indicating the related system to perform an online processing on the media object.

By using the method provided in this embodiment, a restoring processing may be performed in case that the current click is an invalid click on the basis of the embodiment as shown in FIG. 1, such that the displaying of the media object may be controlled more accurately based on the budget.

Alternatively, in an implementation of the embodiment, a status flag for indicating the online/offline status of the media object may be set. When the consumed value of the media object is determined to reach the budget, the status flag is changed from an online status to an offline status, and an offline message is generated according to the status flag. When the current click is determined to be an invalid click, the status flag is changed from the offline status to the online status, and the online message is generated according to the status flag.

It should be noted that the description “a subject 1 acquires a message generated by a subject 2” or another similar description adopted in this disclosure means that the subject 1 may acquire the message generated by the subject 2 in any way. For example, the subject 2 sends the generated message directly to the subject 1, or the subject 1 and the subject 2 transmit data therebetween in a manner of the message queue (MQ). Similarly, the description “the subject 1 generates and sends a message so that the subject 2 performs a certain process” or another similar description adopted in this disclosure means that the subject 1 may send the message to the subject 2 in any way, for example, send directly or send by using a message queue. With regard to the exemplary description of a data flow of this embodiment, reference may be made to the description in the system embodiment.

The method embodiments according to the embodiments of the disclosure are described above in conjunction with the accompanying drawings, and device embodiments according to the embodiments of the disclosure will be described below in conjunction with the accompanying drawings.

FIG. 3 is a schematic block diagram of a device for controlling displaying of a media object according to an embodiment of the disclosure. Referring to FIG. 3, the controlling device 30 includes a consumption updating module 31, a first determining module 32, and a processing module 33, which will be described below, respectively.

The consumption updating module 31 is configured to update a consumed value of the media object based on a current click on the media object by a user after the user clicks the media object.

Alternatively, in an implementation of the embodiment, the consumption updating module 31 may include a message acquiring submodule 311 and an updating submodule 312, as shown by dashed boxes in FIG. 3. The message acquiring submodule 311 is configured to acquire a user click message generated by a media click service subsystem, and trigger the updating submodule 312 when the user click message is acquired, and the updating module 312 is configured to update the consumed value of the media object according to a consumption value carried in the user click message. The media click service subsystem is configured to receive a click on the media object by the user, and generate the user click message indicating that the user clicks the media object when the click on the media object by the user is received. Alternatively, in another implementation of the embodiment, after acquiring the user click message, the message acquiring submodule 311 may trigger the consumption updating module 31 to update the consumed value of the media object based on a pre-stored consumption value of a single click on the media object.

The first determining module 32 is configured to perform a determination based on the consumed value of the media object and a pre-stored budget of the media object, and triggering a processing module in case that the consumed value of the media object is larger than or equal to the pre-stored budget of the media object.

The processing module 33 is configured to generate and send an offline message for instructing a related system to perform an offline processing on the media object.

With the controlling device 30 provided in the embodiment, the real-time dependence on the anti-fraudulence processing during the control of the displaying of a media object is removed by means of the billing processing and the determining processing performed based on the current click, such that it may be determined in time whether an offline processing is to be performed. By generating and sending the offline message when it is determined that the consumed value of the media object reaches the budget, the dependence on the database may be removed, such that the related system may be notified in time to perform the offline processing, and the overall delay in the process of controlling the displaying of a media object based on the budget is reduced, and redundant data processing is also reduced.

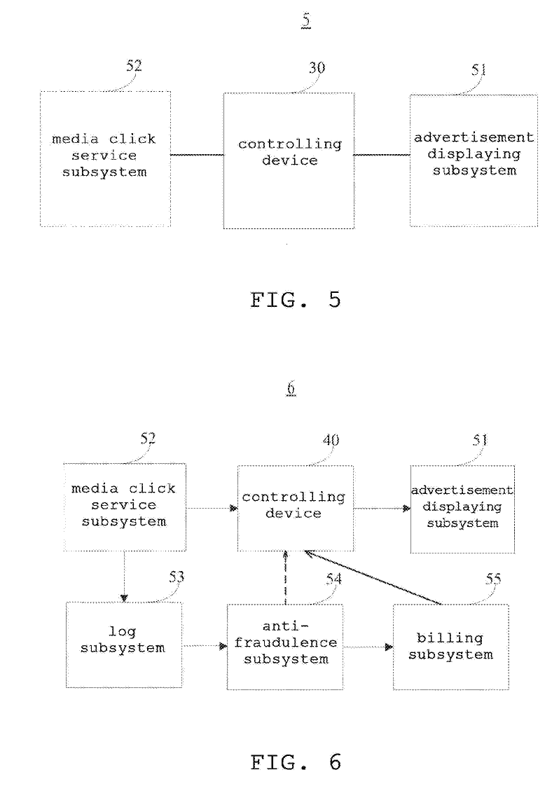

FIG. 4 is a schematic block diagram of a device for controlling displaying of a media object according to an embodiment of the disclosure. Referring to FIG. 4, the controlling device 40 further includes a second determining module 41 in additional to the parts and corresponding functions of the controlling device 30, and the parts are also used for executing other processes, which may be described below, respectively.

The second determining module 41 is configured to determine whether the current click is an invalid click according to an anti-fraudulence strategy, or determine whether the current click is an invalid click according to an acquired indicating message generated by a third-party subsystem, the third-party subsystem being configured to generate the indicating message based on whether the current click is an invalid click. For example, as mentioned above, the third-party subsystem may be an anti-fraudulence subsystem, or a billing subsystem in communication with the anti-fraudulence subsystem.

When the second determining module 41 determines that the current click is an invalid click, the consumption updating module 31 is triggered to perform the following processing: restoring the consumed value of the media object to the value before the updating. For example, the consumption value of the current click is subtracted from the consumed value of the media object.

Besides, when the second determining module 41 determines that the current click is an invalid click, the processing module 33 is also triggered to perform the following processing: generating and sending an online message for instructing the related system to perform an online processing on the media object.

With the controlling device 40 provided in the embodiment, a restoring processing may be performed in case that the current click is an invalid click, such that the displaying of the media object may be controlled more accurately based on the budget.

Alternatively, in an implementation of the embodiment, as shown by dashed boxes in FIG. 4, the controlling device 40 may include a status flag module 42 for setting a status flag for indicating the online/offline status of the media object. Specifically, when the first determining module 32 determines that the consumed value of the media object reaches the budget, the status flag module 42 changes the status flag from the online status to the offline status, so that the consumption updating module 31 generates the offline message according to the status flag. When the second determining module 41 determines that the current click is an invalid click, the status flag module 42 changes the status flag from the offline status to the online status, so that the processing module 33 generates the online message according to the status flag.

FIG. 5 is a schematic block diagram of a media object display system according to an embodiment of the disclosure. Referring to FIG. 5, the media object display system 5 includes the controlling device 30 and an advertisement displaying subsystem 51.

The description with regard to the controlling device 30 may be with reference to the corresponding description in the embodiment as shown in FIG. 3, which is omitted herein. The advertisement displaying subsystem 51 is for acquiring the offline message generated by the controlling device 30, and performing the offline processing on the media object according to the offline message.

With such a media object display system 5, dependence on the database may be removed, such that the problem that an advertisement cannot be offline due to a failure of the database is avoided, and the delay (the delay between the determining of performing the offline processing and the actual performing of the offline processing) caused by a database processing process is reduced. The real-time dependence on the anti-fraudulence process may be removed, and a delay (the delay between the user's click on the media object and the determining of performing the offline processing) caused by the anti-fraudulence processing may be reduced. The displaying of the media object may be controlled with a short path in the whole, such that the delay may be reduced (e.g., from minute level to second level) and redundant processing due to a long delay may be reduced so as to save the system resources. Besides, taking the advertising in search results as an example, the proportion of invalid advertisements in the search results may be decreased, and the search experience of network users may be enhanced.

Alternatively, in an implementation of the embodiment, as shown by dashed boxes in FIG. 5, the media object display system 5 may further include a media click service subsystem 52 for receiving a click on the media object by the user, and generating and sending a user click message indicating that the user clicks the media object after the click by the user is received, such that the controlling device 30 acquires the user click message so as to update the consumed value of the media object.

Alternatively, in an implementation of the embodiment, the controlling device 30 may include the second determining module 41, like the controlling device 40. However, in this case, the second determining module 41 may be configured only to determine whether the current click is an invalid click according to the anti-fraudulence strategy. Accordingly, the consumption updating module 31 and the processing module 32 may perform the processing in the embodiment as shown in FIG. 4. The advertisement displaying subsystem 51 may acquire the offline message and perform the offline processing.

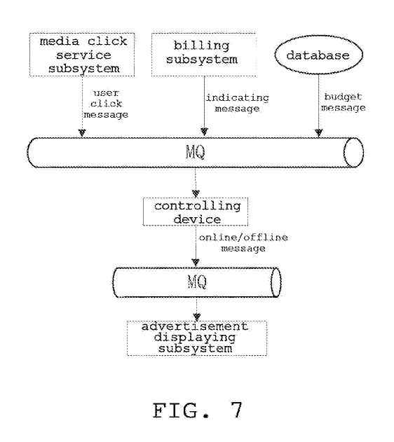

FIG. 6 is a schematic block diagram of a media object display system according to an embodiment of the disclosure. Referring to FIG. 6, the media object display system 6 includes a controlling device 40, an advertisement displaying subsystem 51, a media click service subsystem 52, a log subsystem 53, an anti-fraudulence subsystem 54 and a billing subsystem 55.

In the embodiment, the user click messages generated by the media click service subsystem 52 are acquired by the controlling device 40 and the log subsystem 53, respectively. The processing performed by the controlling device 40 according to the user click message is described above. After saving a click log of the media object, the log subsystem 53 triggers the anti-fraudulence subsystem 54 to determine whether the current click is an invalid click according to an anti-fraudulence strategy.

Alternatively, in an implementation of the embodiment, the anti-fraudulence subsystem 54 generates, according to a determining result, an indicating message for indicating whether the current click is an invalid click, which is acquired by the controlling device 40. For example, when determining that the current click is an invalid click, the anti-fraudulence subsystem 54 generates an indicating message indicating that the current click is an invalid click, so that the controlling device 40 performs a restoring processing after acquiring the message. Alternatively, the anti-fraudulence subsystem 54 may also generate a corresponding indicating message when determining that the current click is a valid click, so that the controlling device 40 determines that the restoring processing does not need to be performed.

Alternatively, in an implementation of the embodiment, the billing subsystem 55 determines whether a billing processing is performed based on a result of the determining of the anti-fraudulence subsystem 54, and if the result of the determining is that the current click is an invalid click, the billing subsystem 55 does not perform the billing processing and generates the indicating message for indicating the billing processing is not performed. The controlling device 40 may determine that the current click is an invalid click after acquiring the message so as to perform the restoring processing. After the restoring processing is performed, the advertisement displaying subsystem 51 performs the online processing according to the acquired online message.

Alternatively, if the result of determining is that the current click is a valid click, the billing processing is performed (e.g., accumulating the consumption value of each valid click) to obtain an effective consumption value, and an indicating message for indicating the charging completion is generated. The controlling device 40 may determine that the current click is a valid click when the message is acquired, and then the restoring processing is not needed.

Besides, in the case of performing the billing processing, the billing subsystem 55 may also send the obtained effective consumption value to the controlling device 40, and the controlling device 40 may directly use the effective consumption value as the consumed value of the media object.

Alternatively, in an implementation of the embodiment, the media object display system 6 may further include a database (not illustrated). The effective consumption value calculated by the billing subsystem 55 or the consumed value calculated by the controlling device 40 (or controlling device 30) may be saved in the database. The controlling device 40 (or controlling device 30) may also acquire the budget of the media object from the database.

It should be appreciated by a person skilled in the art that some parts in the embodiment may be integrated with one another to realize the objective of the disclosure. For example, the controlling device 40 may be integrated with the function of the charging subsystem 55, and some parts in the embodiment may be omitted, for example, the log subsystem 53.

In practical manufacture, the processing performed by the controlling device 30 and the controlling device 40 may be performed by a server.

FIG. 7 is a schematic diagram of a data flow in a process of controlling the display of a media object display according to an embodiment of the disclosure. Referring to FIG. 7, a media click service subsystem sends a user click message to a message queue MQ, a billing subsystem sends an indicating message to the message queue MQ, and a database sends a budget message containing the budget information to the message queue MQ. A control device subscribes to the messages in the message queue MQ, and performs the above-mentioned processing if the user click message or the indicating message is acquired. If the budget message is acquired, the control device changes the pre-stored budget, and performs the processing with the concept of the disclosure according to the updated budget. If a preset status flag is changed, the control device generates a corresponding online message or offline message according to the changed status flag, and sends the online message or the offline message to the message queue MQ. An advertisement displaying subsystem performs a corresponding processing after acquiring the online message or the offline message from the message queue MQ.

An example of the processing flow according to the disclosure is simply described below. It is assumed that the budget is RMB 100, each of the currently consumed value and the effective consumption value is RMB 99, and the remaining budget is RMB 1. When a raw click of RMB 5 reaches the control device (having a delay at the second level), the consumed value is updated to RMB 104 (the remaining budget is RMB −4 at this moment), which is larger than the budget RMB 100, and then the status flag is set to an offline status and the offline message is sent from the message queue MQ to the advertisement displaying subsystem to perform the offline processing. After a while (e.g., the minute level), if it is learned from the indicating message that the click of RMB 5 is not billed, its consumption value is withdrawn, the consumed value is changed to RMB 99 (the remaining budget is changed to RMB 1), the status flag is set to the online status, and an online message is sent from the message queue MQ to the advertisement displaying subsystem to perform an online processing. If the click of RMB 5 is already billed, the consumed value is not changed, the status flag is kept in the offline status, and no message is sent to the advertisement displaying subsystem.

A device (referred to as device A) is further provided in other embodiments of the disclosure, including: one or more processors; a memory; and one or more programs. The one or more programs are stored in the memory. When the one or more programs are executed by the one or more processors, the steps included in the above-mentioned method for controlling displaying of a media object or the implementations thereof are performed.

A non-transitory computer storage medium is further provided in other embodiments of the disclosure. One or more programs are stored in the computer storage medium. When the one or more programs are executed by a device (e.g., device A), the device will perform the steps included in the above-mentioned method for controlling the displaying of a media object or the implementations thereof.

According to the descriptions of the above embodiments, it may be clear for a person skilled in the art to understand that the disclosure may be implemented in a manner of combining software with a hardware platform. On the basis of such understanding, the whole or a part of the contribution of the technical solutions of the disclosure over the prior art may be embodied in the form of a software product. The computer software product may be stored in a storage medium, such as ROM/RAM, a magnetic disk, and an optical disk, and include a plurality of instructions intended to enable a computer device (it can be a personal computer, a server, a smart phone, a network device, or the like) to perform the methods described in the embodiments of the disclosure or in some parts of the embodiments.

Terms and wordings used in the description are merely intended to illustrate, but not to limit. It should be appreciated by a person skilled in the art that various variations may be made to the details in the above embodiments without departing from basic principles of the disclosed embodiments. Hence, the scope of the present invention is determined only by claims. In the Claims, unless otherwise stated, all the terms should be understood to have the broadest and most reasonable meanings.

1. A method for controlling displaying of a media object, comprising:
updating a consumed value of the media object based on a current click on the media object by a user after the user clicks the media object;
performing a determination based on the consumed value of the media object and a pre-stored budget of the media object; and
generating and sending an offline message for instructing a related system to perform an offline processing on the media object when the consumed value of the media object is determined to reach the budget.

2. The method according to claim 1, wherein the updating of a consumed value of the media object based on a current click on the media object by a user after the user clicks the media object comprises:
updating the consumed value of the media object according to a consumption value carried in a user click message when the user click message generated by a media click service subsystem is acquired;
wherein the media click service subsystem is configured to receive a click on the media object by the user, and generate the user click message indicating that the user clicks the media object when the click on the media object by the user is received.

3. The method according to claim 1, further comprising:
determining whether the current click is an invalid click according to an anti-fraudulence strategy, or
determining whether the current click is an invalid click according to an acquired indicating message generated by a third-party subsystem, the third-party subsystem being configured to generate the indicating message based on whether the current click is an invalid click; and
performing a restoring processing if the current click is an invalid click, the restoring processing comprising:
restoring the consumed value of the media object to the value before the updating; and
generating and sending an online message for instructing the related system to perform an online processing on the media object.

4. The method according to claim 3, further comprising:
changing a preset status flag from an online status to an offline status and generating the offline message according to the status flag, when the consumed value of the media object is determined to reach the budget; and
changing the status flag from the offline status to the online status and generating the online message according to the status flag, when the current click is determined to be an invalid click.

5. A device for controlling displaying of a media object, comprising:
a consumption updating module configured to update a consumed value of the media object based on a current click on the media object by a user after the user clicks the media object;
a first determining module configured to perform a determination based on the consumed value of the media object and a pre-stored budget of the media object, and trigger a processing module in case that the consumed value of the media object is larger than or equal to the pre-stored budget of the media object; and
the processing module configured to generate and send an offline message for instructing a related system to perform an offline processing on the media object.

6. The device according to claim 5, wherein the consumption updating module comprises:
a message acquiring submodule configured to acquire a user click message generated by a media click service subsystem, and trigger an updating submodule when the user click message is acquired; and
the updating submodule configured to update the consumed value of the media object according to a consumption value carried in the user click message;
wherein the media click service subsystem is configured to receive a click on the media object by the user, and generate the user click message indicating that the user clicks the media object when the click on the media object by the user is received.

7. The device according to claim 5, further comprising:
a second determining module configured to determine whether the current click is an invalid click according to an anti-fraudulence strategy, or determine whether the current click is an invalid click according to an acquired indicating message generated by a third-party subsystem, the third-party subsystem being configured to generate the indicating message based on whether the current click is an invalid click;
wherein the consumption updating module is further configured to restore the consumed value of the media object to the value before the updating when the second determining module determines that the current click is an invalid click; and
the processing module is further configured to generate and send an online message for instructing the related system to perform an online processing on the media object when the second determining module determines that the current click is an invalid click.

8. The device according to claim 7, further comprising:
a status flag module configured to change a preset status flag from an online status to an offline status when the first determining module determines that the consumed value of the media object is larger than or equal to the budget, such that the consumption updating module generates the offline message according to the status flag, and configured to change the status flag from the offline status to the online status when the second determining module determines that the current click is an invalid click, such that the processing module generates the online message according to the status flag.

9. A media object display system, comprising:
the device according to claim 5; and
an advertisement displaying subsystem configured to acquire a message generated by the device, and perform an online processing or an offline processing on the media object according to the acquired message.

10. The system according to claim 9, further comprising:
a media click service subsystem configured to receive a click on the media object by the user, and generate and send a user click message indicating that the user clicks the media object after the click by the user is received, such that the device acquires the user click message so as to update the consumed value of the media object.

11. The system according to claim 9, further comprising:
a third-party subsystem configured to generate an indicating message based on whether the current click is an invalid click, such that the device acquires the indicating message and determines whether the current click is an invalid click according to the indicating message.

12. The system according to claim 11, wherein
the third-party subsystem is an anti-fraudulence subsystem, configured to determine whether the current click is an invalid click according to an anti-fraudulence strategy, and generate the indicating message based on a result of the determining.

13. The system according to claim 11, further comprising:
an anti-fraudulence subsystem configured to determine whether the current click is an invalid click according to an anti-fraudulence strategy;
wherein the third-party subsystem is a billing subsystem configured to determine whether a billing processing is performed based on a result of the determining of the anti-fraudulence subsystem, and if the result of the determining is that the current click is an invalid click, the third-party subsystem does not perform the billing processing and generates the indicating message for indicating the billing processing is not performed such that the device determines that the current click is an invalid click according to the indicating message.

14. A device, comprising:
one or more processors;
a memory; and
one or more programs stored in the memory, wherein when the one or more programs are executed by the one or more processors, the following operations are carried out;
updating a consumed value of the media object based on a current click on the media object by a user after the user clicks the media object;
performing a determination based on the consumed value of the media object and a pre-stored budget of the media object; and
generating and sending an offline message for instructing a related system to perform an offline processing on the media object when the consumed value of the media object is determined to reach the budget.

15. A non-transitory computer storage medium storing one or more programs, the one or more programs when executed by a device, causing the device to perform operations comprising the steps in the method for controlling displaying of a media object according to claim 1.

16. The device according to claim 14, wherein the updating of a consumed value of the media object based on a current click on the media object by a user after the user clicks the media object comprises:
updating the consumed value of the media object according to a consumption value carried in a user click message when the user click message generated by a media click service subsystem is acquired;
wherein the media click service subsystem is configured to receive a click on the media object by the user, and generate the user click message indicating that the user clicks the media object when the click on the media object by the user is received.

17. The device according to claim 14, the operations further comprising:
determining whether the current click is an invalid click according to an anti-fraudulence strategy, or
determining whether the current click is an invalid click according to an acquired indicating message generated by a third-party subsystem, the third-party subsystem being configured to generate the indicating message based on whether the current click is an invalid click; and
performing a restoring processing if the current click is an invalid click, the restoring processing comprising:
restoring the consumed value of the media object to the value before the updating; and
generating and sending an online message for instructing the related system to perform an online processing on the media object.

18. The device according to claim 17, the operations further comprising:
changing a preset status flag from an online status to an offline status and generating the offline message according to the status flag, when the consumed value of the media object is determined to reach the budget; and
changing the status flag from the offline status to the online status and generating the online message according to the status flag, when the current click is determined to be an invalid click.
